(19) United States
(12) Patent Application Publication
(10) Pub. No.: US 2004/0260787 A1
(43) Pub. Date: Dec. 23, 2004

(54) URL-format links in log records

(75) Inventor: Juha Havulinna, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/640,303

(22) Filed: Aug. 14, 2003

Related U.S. Application Data
(60) Provisional application No. 60/479,508, filed on Jun. 19, 2003.

(51) Int. Cl. G06F 15/16

(52) U.S. Cl. 709/217; 709/224

(57) ABSTRACT

A representative method and a system for providing link information in log records. At least one link is typically provided in Uniform Resource Locator format, the link is generally included in a first log record of a first log arranged in a first computing system. The link may point, for example, to a second log record of the first log, to a log record of a second log arranged in the first computing system, to a log record of a third log arranged in a second computing system, and/or to given non-log data. The method and system generally allow for shorter administrative and troubleshooting time, one point to access all the required logs, and/or easy log integration between systems.

### CROSS REFERENCE TO RELATED APPLICATIONS

This application claims priority of U.S. States Provisional Patent Application Ser. No. 60/479,508, entitled “URL-Format Links in Log Records,” filed on Jun. 19, 2003, the contents of which are hereby incorporated by reference in their entirety.

### BACKGROUND OF THE INVENTION

1. Field of the Invention

The present specification relates to communications technology. In particular, the present specification relates to a novel and improved method and system for providing link information in log records.

2. Description of the Related Art

Various computing systems, such as communication network elements and communication network management systems, typically log information about system activities. For example, telecommunication networks routinely utilize logging. The term logging is used here to refer to writing information about an occurred event or events to a log. A log record generally refers to a record containing thus written information about an occurred event or a series of related events. A log typically includes a group of log records somehow related to each other. Thus a log is normally a logical entity. Typically, a log is stored in one file, but it may also be stored in several files.

Typically, a written log record is kept for further analysis and possible subsequent actions based on a performed analysis. Analysis is often performed by people, such as administrative personnel, but it may also be automated at least partly. The overall objective is generally to understand what has happened and why, in order to perform corrective actions, if needed. Examples of logs according to the related art include debug logs, trace logs, error logs, problem reporting logs, and audit trails including security logs and system logs. Corrective actions may be based on one or several logs, even on several logs from several different computing systems, and they often include changing program code, changing program or program version or patch level, changing execution environment configuration, changing user behavior by way of instructing or training, changing malfunctioning hardware, and/or changing user documentation or system documentation. In short, log information analysis between several logs is commonly a very typical part of everyday troubleshooting and maintenance of computing systems, especially that of communication networks.

Thus, for example, when an event or a set of events occurs where several computing systems are interacting with each other, in other words a transaction occurs, information about the transaction is typically written to several log records in several different logs. It is often preferable to somehow associate these related logs to each other in order to facilitate analyzing them later on. The related art generally features two basic categories for approaching this preferable condition: centralized logs and distributed logs.

With centralized logs, logs are generally collected to one centralized place. However, this approach has several significant disadvantages. Sending log records from one system to another often requires various computing services to be available. Often, the most valuable information relates to events occurring while these computing services are malfunctioning or otherwise not available, thus preventing collecting log records. To overcome this problem, systems with centralized logs often utilize two parallel logs. The system generally first writes log records to local logs and then commonly sends these log records to a centralized log. However, this practice usually entails other problems because it is typically not particularly effective with regards to computing resources; for example, extra central processing unit (CPU) resources, extra local area network (LAN) resources, as well as extra disk resources, are often required. Further, system architecture is generally not scalable. Thus, centralized logging often becomes a bottleneck to system performance.

With distributed logs, logs commonly remain distributed in several various places. Typically, each log has some kind of identifier associated with it. For example, a log often has a time stamp in addition to a hostname, a username, and/or a transaction identifier. Thus, these identifiers often serve to associate related logs with each other. However, there are still typically several significant problems. For example, a significant amount of experience, including a knowledge of which logs are available, where are they located, and/or what they include, is commonly highly preferable when performing administrative tasks such as, but not limited to, investigating the system logs since the log files are typically located in various different locations in the file system of a computing system or, as is often the case, in the file systems of several computing systems. Further, it generally takes a significant amount of time to log into each computing system in order to investigate logs located there. Further, even with the use of identifiers, it is often difficult to comprehend exactly how log records of different logs relate to each other, even if they report a same external event.

Thus, there is typically a need for a more sophisticated approach for linking related log records to each other.

### SUMMARY OF THE INVENTION

Certain embodiments of the present invention are related to methods and systems for providing link information in log records. According to one embodiment, a first computing system includes a first log which typically includes at least one log record, including a first log record. At least one log record commonly includes at least one link. According to certain embodiments of the present invention, at least one link is provided in Uniform Resource Locator (URL) format. Uniform Resource Locator format generally refers to a format standard according to the related art developed by the Network Working Group of the World Wide Consortium (W3C). Typically, it is used to reference web pages in a web browser. A URL is typically a string that uses a standard syntax to identify, for example, an access protocol, location, and/or identifier for a file or other resource.

In an embodiment of the present invention, the first log further includes a second log record, and the at least one link generally provided in Uniform Resource Locator format typically points to the second log record.

In an embodiment of the present invention, the first computing system further includes a second log which commonly includes at least one log record, and the at least one link generally provided in Uniform Resource Locator format often points to a log record in the second log.

In an embodiment of the present invention, the system for providing link information further includes a second computing system which commonly includes a third log which generally includes at least one log record. The second computing system is typically connected to the first computing system via a communication network, and the at least one link generally provided in Uniform Resource Locator format commonly points to a log record in the third log.

In an embodiment of the present invention, the at least one link generally provided in Uniform Resource Locator format usually points to appropriate predetermined non-log data, for example, to administrative documentation and/or to a file in the same computing system or in a remote computing system.

In an embodiment of the present invention, the log records linked together by the links generally provided in Uniform Resource Locator format often include information related to a common event or a set of events.

One advantage of certain embodiments of the invention is that, compared to the related art, certain embodiments of the present invention allow for shorter administrative and troubleshooting time. Since system administrators and/or field engineers typically save time, logs may be accessed faster. Ultimately, this typically results in faster system problem solving time. Further, certain embodiments of the present invention allow for one point to access all the required logs. A user is generally not required to know the actual location of logs, nor is the user generally required to know which logs a particular system includes.

Further, certain embodiments of the present invention allow for easy log integration between systems. Logs commonly may be linked between different systems, between different vendors, and/or independent underlying computing technology. Additionally, the links generally may be maintained automatically without user interactions. Further, certain embodiments of the present invention allow for integration with electrical user documentation, as logs may be linked with, for example, system administration documentation. Further, certain embodiments of the present invention allow for higher reliability and better resource usage. Log files may be distributed in an optimum way, and there is typically no need to collect logs in one place in order to gain easy access. Additionally, writing logs locally tends to be more reliable and less resource consuming than sending log records over to other systems.

### BRIEF DESCRIPTION OF THE DRAWINGS

The accompanying drawings, which are included to provide a further understanding of certain embodiments of the present invention and constitute a part of this specification, illustrate embodiments of the invention and, together with the detailed description, help to explain the principles of certain embodiments of the present invention. In the drawings:

FIG. 1 is a block diagram illustrating a system for providing link information in log records according to one embodiment of the invention; and

FIG. 2 illustrates a method for providing link information in log records according to one embodiment of the invention.

### DETAILED DESCRIPTION OF THE PREFERRED EMBODIMENTS

Reference will now be made in detail to certain embodiments of the present invention, examples of which are illustrated in the accompanying drawings.

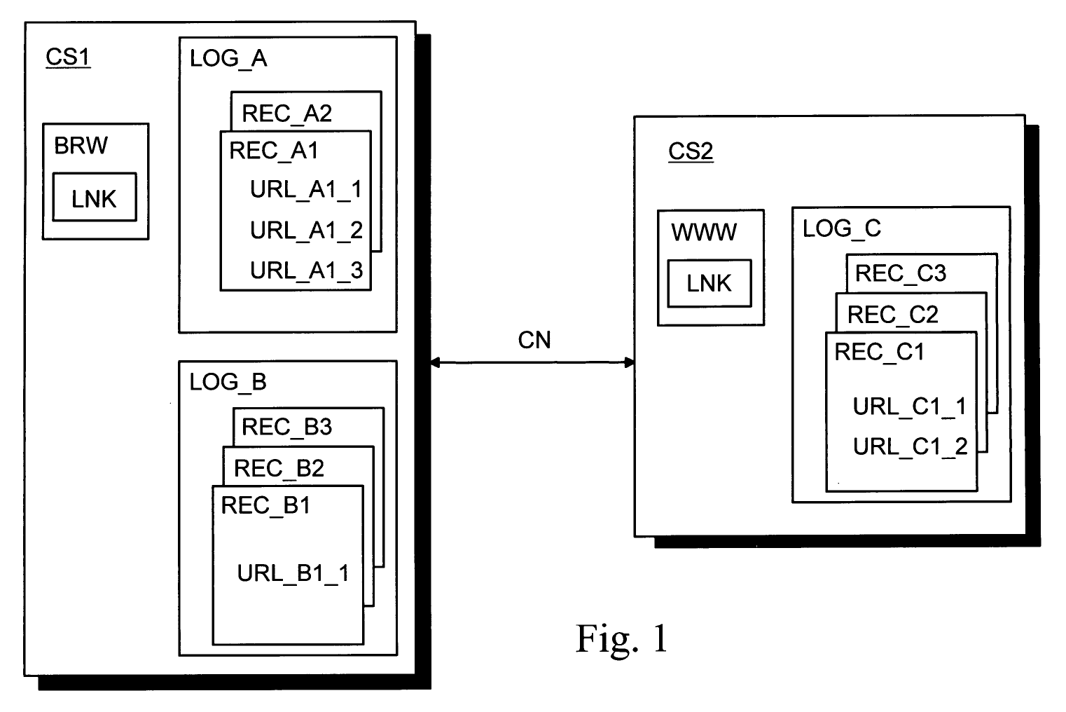

FIG. 1 illustrates a system for providing link information in log records according to one embodiment of the present invention. In the exemplary embodiment of the invention illustrated in FIG. 1, the system for providing link information includes a first computing system CS1 and a second computing system CS2. The second computing system CS2 has usually been connected to the first computing system CS1 via a communication network CN. The communication network CN1 may be, for example, a telecommunication network, and the computing systems CS1 and CS2 may be, for example, network elements of the telecommunication network.

The first computing system CS1 generally includes a first log LOG_A. In the exemplary embodiment of the invention illustrated in FIG. 1, the first log LOG_A typically includes log records, including a first log record REC_A1 and a second log record REC_A2. Further, in the exemplary embodiment of the invention illustrated in FIG. 1, the first computing system CS 1 further often includes a second log LOG_B commonly including several log records, REC_B1 to REC_B3. Further, in the exemplary embodiment of the invention illustrated in FIG. 1, the second computing system CS2 generally includes a third log LOG_C usually including several log records, REC_C1 to REC_C3. The logs LOG_A to LOG_C may be, for example, debug logs, trace logs, error logs, problem reporting logs, and/or audit trails. It should be noted that, although FIG. 1 depicts only a few log records for the sake of clarity, there is typically a multitude of log records in many actual implementations.

In the exemplary embodiment of the invention illustrated in FIG. 1, the log records may be used to, for example, write information about transactions occurring in the network elements for later analysis. To facilitate this later analysis, it is often desirable to link related logs to each other. According to certain embodiments of the present invention, the system for providing link information typically further includes link means and/or apparatus LNK for providing at least one of these links in Uniform Resource Locator format. Thus, as illustrated in FIG. 1, the log records REC_A1, REC_B1 and REC_C1 generally include links in Uniform Resource Locator format, for example, URL_A1_1 to URL_A1_3, and URL_B1_1 and URL_C1_1 to URL_C1_2, respectively. These links may point, for example, to log records in the same log, to log records in another log in the same computing system, to log records in another log in another computing system, and/or to appropriate predetermined non-log data, for example, administrative documentation and/or to a file in the same computing system and/or in a remote computing system. Under most circumstances, log records REC_A2, REC_B2, REC_B3, REC_C2 and/or REC_C3 may also include links in Uniform Resource Locator format, although, for the sake of clarity, such links are not illustrated in FIG. 1. Again, although, for the sake of clarity, FIG. 1 depicts only a few links, there is typically a multitude of links in actual implementations.

As the Uniform Resource Locator format is in itself well known, there are typically various ways to implement the link means and/or apparatus LNK, as will become known to a person skilled in the art upon practicing embodiments of the present invention. To facilitate utilization of certain links in Uniform Resource Locator format, in the exemplary embodiment of the invention illustrated in FIG. 1, a log browser BRW and a web server WWW have been implemented in connection with the link means and/or apparatus LNK for browsing log records.

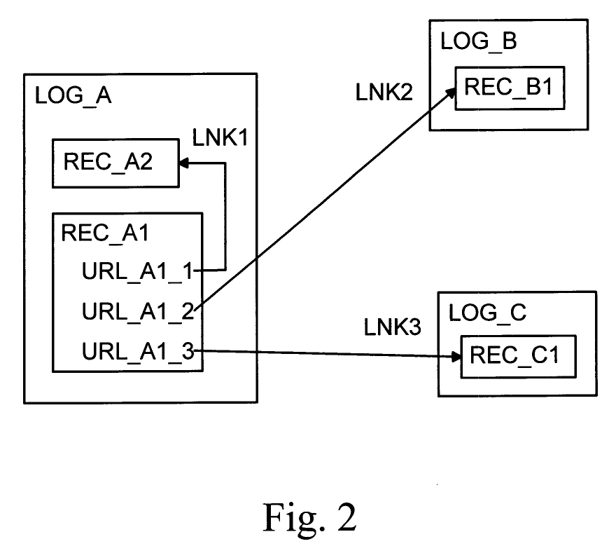

FIG. 2 illustrates a representative method for providing link information in log records according to one embodiment of the present invention.

A representative first log record REC_A1 of a representative first log LOG_A arranged in a representative first computing system (not depicted) has been provided with a representative first link in Uniform Resource Locator format, URL_A1_1. In the exemplary embodiment of the invention illustrated in FIG. 2, the first link URL_A1_1 points to a second log record REC_A2 of the first log LOG_A.

In the exemplary embodiment of the invention illustrated in FIG. 2, the first log record REC_A1 of the first log LOG_A has been further provided with a second link in Uniform Resource Locator format, URL_A1_2. In the exemplary embodiment of the invention illustrated in FIG. 2, the second link URL_A1_2 points to a representative log record REC_B1 of a representative second log LOG_B arranged in the representative first computing system (not depicted).

In the exemplary embodiment of the invention illustrated in FIG. 2, the representative first log record REC_A1 of the representative first log LOG_A has been further provided with a representative third link in Uniform Resource Locator format, URL_A1_3. In the exemplary embodiment of the invention illustrated in FIG. 2, the representative third link URL_A1_3 points to a representative log record REC_C1 of a representative third log LOG_C arranged in a representative second, remote computing system (not depicted).

Although not explicitly depicted here, links in Uniform Resource Locator format may also point to appropriate predetermined non-log data, for example, to administrative documentation and/or to a file or files on local or remote computing systems.

Upon practicing embodiments of the present invention, it will become apparent to a person skilled in the art that, with the advancement of technology, certain embodiments of the present invention may be implemented in various ways. The invention and its embodiments are thus not limited to the examples described above. Instead they may vary within the scope of the claims.

What is claimed is:

1. A method for providing link information in log records, wherein the method comprises the step of:
providing at least one link in Uniform Resource Locator format, said link included in a first log record of a first log arranged in a first computing system.

2. The method according to claim 1, further comprising pointing said at least one link provided in Uniform Resource Locator format to a second log record of said first log.

3. The method according to claim 1, further comprising pointing said at least one link provided in Uniform Resource Locator format to a log record of a second log arranged in said first computing system.

4. The method according to claim 1, further comprising pointing said at least one link provided in Uniform Resource Locator format to a log record of a third log arranged in a second computing system, said second computing system connected to said first computing system via a communication network.

5. The method according to claim 1, further comprising pointing said at least one link provided in Uniform Resource Locator format to given non-log data.

6. The method according to claim 1, wherein the providing step comprises that the log records linked together by said links provided in Uniform Resource Locator format comprise information related to a common event or a set of events.

7. A system for providing link information in log records, wherein the system for providing link information comprises:
a first computing system comprising a first log comprising a first log record comprising at least one link, and
a link apparatus for providing said at least one link in Uniform Resource Locator format.

8. The system according to claim 7, wherein said first log further comprises:
a second log record, and
wherein said link apparatus are arranged to point said at least one link provided in Uniform Resource Locator format to said second log record.

9. The system according to claim 7, wherein said first computing system further comprises:
a second log comprising at least one log record, and
wherein said link apparatus are arranged to point said at least one link provided in Uniform Resource Locator format to a log record in said second log.

10. The system according to claim 7, wherein said system for providing link information further comprises:
a second computing system comprising a third log comprising at least one log record, said second computing system connected to said first computing system via a communication network, and
wherein said link apparatus are arranged to point said at least one link provided in Uniform Resource Locator format to a log record in said third log.

11. The system according to claim 7, wherein said link apparatus are arranged to point said at least one link provided in Uniform Resource Locator format to given non-log data.

12. The system according to claim 10, wherein said communication network is a telecommunication network, and said computing systems are network elements of said telecommunication network.

13. The system according to claim 7, wherein the log records linked together by said links provided in Uniform Resource Locator format comprise information related to a common event or a set of events.

14. A system for providing link information in log records, wherein the system for providing link information comprises:
a first computing means comprising a first logging means comprising a first log recording means comprising at least one link, and
a linking means for providing said at least one link in Uniform Resource Locator format.
